(19) United States
(12) Patent Application Publication
(10) Pub. No.: US 2008/0000763 A1
(43) Pub. Date: Jan. 3, 2008

(54) Push Button Assembly

(76) Inventor: James Cove, Surrey (GB)

Correspondence Address: GREENBLUM & BERNSTEIN, P.L.C., 1950 ROLAND CLARKE PLACE, RESTON, VA, 20191, US

(21) Appl. No.: 11/665,126

(22) PCT Filed: Oct. 17, 2005
(86) PCT No.: PCT/GB05/03978

§ 371 Date: Jun. 5, 2007

(30) Foreign Application Priority Data
Oct. 15, 2004 (GB) 0422927.4

(51) Int. Cl. H01H 13/02; A63F 9/24

(52) U.S. Cl. 200/314; 463/37; 200/317

(57) ABSTRACT

A push button assembly has a light transmitting button (1) which is movable against a spring (3) within a housing. A switch (16) and lamp (15) are provided in an integrated unit (4) and mounted at an open bottom end of the housing. The housing (2) has a peripheral flange (10) at an upper open end from which a peripheral skirt part (18) projects downwardly, the skirt part (18) defining a boundary. The lamp provides the first illumination means to illuminate the button (1). A second illumination means is provided to illuminate the boundary defined by said skirt (18) to create a ‘halo’ around the button. This second illumination means is provided by an arrangement of LEDs (19a) on a circuit board (19) which are independently controllable from each other and from said lamp (15) to provide a greater variety of lighting arrangements and therefore possible button status indicators.

### TECHNICAL FIELD

The invention relates to push button assemblies and in particular, although not exclusively is concerned with push button assemblies for use in amusement or gaming machines.

### BACKGROUND ART

Conventionally, push button assemblies for amusement or gaming machines comprise a light transmitting button which is manually movable against a spring force to operate an electrical switch and which can be illuminated e.g. by an internal lamp, to attract attention to the button to indicate the current functional status of the associated switch with regard to the game played with the machine. For example, where the assembly is a start button assembly the button may be illuminated with a steady or flashing light to indicate that the button can be pressed to initiate game play, the button otherwise being non-illuminated or differently illuminated.

GB 2350722 provides a push button assembly with which the button is surrounded by an external bezel that has an array of illuminable LEDs beneath it. Light is transmitted by light conducting elements to the bezel to provide a display of light spots which can twinkle or alternate to give an attractive changing pattern.

An object of the present invention is to provide a more varied illumination arrangement for a push button assembly to facilitate a greater versatility of uses for the assembly.

### DISCLOSURE OF INVENTION

According to one aspect of the invention therefore there is provided a push button assembly comprising an electrical switch, a light transmitting button movable to operate the switch and a first illumination means for illuminating the button, characterised in that a second illumination means is provided for illuminating a boundary at least partially around the button, wherein the first and second illumination means are controllable separately.

With this arrangement, the boundary and the button can be illuminated on different occasions, in different combinations or kinds of illumination such as steady illumination, flashing illumination, different colours of illumination, different extents of illumination around the boundary, and so on. The different illumination arrangements can be used to facilitate greater versatility of use of the push button assembly, for example by indicating different operational statuses for the electrical switch which may be related to different stages or events for use of the switch, for example different stages or events in a game played with an amusement or gaming machine indicated or controlled by the switch.

The first and second illumination means may comprise separate illumination sources which are operable separately. Alternatively there may be a common source with separately controllable illumination links between the source and the button and the boundary thereby to provide the separately controllable illumination means.

The illuminable boundary may extend partially or wholly around the button in one or a plurality of independently illuminable segments. In a particularly preferred embodiment the boundary is illuminable as a single segment which extends in a closed or substantially closed track around the button, thereby defining a ‘halo’ ring around the button. The boundary may be curved or angular and thus may be circular or rectangular or of any other shape.

The (or each) segment of the boundary is preferably such as to provide an elongate visually continuous light path which may be of the form of a narrow line or strip. This may be achieved by using a continuous elongate light source but most preferably comprises multiple light sources located closely adjacent to each other to give the effect of continuous light or one or more light sources with a light distributing or confining device such as a lens or diffuser or filter or the like which spreads or deflects or confines the light along a continuous path, whereby the light sources need not be elongate and may be ‘point’ sources or the like.

The assembly may comprise a housing on which the first and second illumination means, the light transmitting button and the switch are mounted.

The housing may comprise a hollow tubular body such as a cylindrical body open at opposite ends.

An actuating structure may be movably mounted within the housing for transmitting movement of the button to the switch for operating thereof.

A spring means may be provided in the housing for spring loading the actuating structure.

The switch may be mounted beneath an open bottom end of the housing and the actuating structure may have a foot which projects beyond the bottom end for operable engagement with the switch.

The button may comprise a cap which projects beyond an open top end of the housing and is movable within limits into and out of the housing.

The first illumination means may comprise a lamp, such as a filament lamp or LED which may be mounted within the housing. Suitably the lamp may be attached to the switch to form a unit therewith which is detachably engageable with the housing.

The housing preferably has a peripheral flange e.g. around the aforesaid open top end of the housing to define a bezel around the button.

The second illumination means is preferably located within a peripheral part separate from the flange, preferably beneath the flange, to produce the boundary illumination through such part which is thereby appropriately light transmitting. In this case the flange need not be light transmitting, and may be opaque thereby to define a non-illuminable boundary between the button and the illuminable boundary.

The flange and the aforesaid peripheral part may be of any suitable shape and thus may be generally ring shaped of circular or square or rectangular conformation and may be the same as or different from the cross-sectional shape of the aforesaid tubular body of the housing.

Preferably the second illumination means comprises a series of discrete LEDs. These are preferably provided on a printed circuit board. The LEDs are preferably arranged around a periphery of the board and may be individually controllable.

Alternatively, an electroluminescent film or wire may be used which contacts a circuitry and passes a current through the film or wire resulting in a glow being emitted. The electroluminescent film or wire may be enclosed within or embedded in the aforesaid peripheral part. Alternatively the film or wire may be located in a groove provided around the periphery of the flange or the peripheral part. A single electroluminescent wire may be used to provide a continuous closed loop illumination path.

The second illumination means may emit white or coloured light when energised and may be arranged to emit a single coloured or multi-coloured line of light to the boundary.

The push button assembly may have separate electrical connections or terminals for the two illumination means so that they may be controlled separately from one another.

In use these separate connections and terminals may be connected to operating circuitry of an amusement or gaming machine so that they are activated in different ways on different occasions in correspondence with different game play stages, features or modes. In this respect the halo can be activated independently of the button illumination, and the halo may not represent an activation status of the button but instead may be operable in a mode where the machine is not yet actuated for play, e.g. in an attract mode.

In accordance with a second aspect of the invention there is provided an entertainment machine operable under the control of an operating system to play a game when actuated by credit of a predetermined stake value, said machine having at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, characterised in that the button assembly is actuable in first and second modes for initiating first and second different respective said game steps and in each said mode the button is arranged to be illuminated by a respective one of the first and second said illumination means.

In accordance with a third aspect of the invention there is provided an entertainment machine operable under the control of an operating system to play a game when actuated by credit of a predetermined stake value, said machine having at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, the button assembly being actuable in first and second modes for initiating first and second different respective said game steps and, in each said mode the button is arranged to be illuminated by a respective one of the first and second said illumination means, and wherein the machine is also operable in an attract mode when not actuated as aforesaid to play a game characterised in that in the said attract mode the second illumination means is operable for illuminating the button, but not the first illumination means.

In accordance with a fourth aspect of the invention there is provided an entertainment machine operable under the control of an operating system to play a game when actuated by credit of a predetermined stake value, said machine having at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, characterised in that the second illumination means is arranged to illuminate a boundary at least partially around the button.

The second, third and fourth aspect may be combined with the features of the first aspect of the invention as appropriate.

Accordingly, therefore and in accordance with a fifth aspect of the invention there is provided a method for operation of a push button assembly having an electrical switch, a light transmitting button movable to operate the switch, a first illumination means for illuminating the button and a second illumination means for illuminating a boundary, at least partially around the button, where the first and second illumination means are separately controllable, comprising the step of:

activating the second illumination means without activation of the first illumination means to indicate a mode of the button which does not indicate an active status of the button.

When used with an amusement or gaming machine the push button assembly may be mounted on a panel of the machine by insertion of the aforementioned housing through an aperture in the panel so that the aforementioned flange and the push button are on the outer side of the panel. A suitable attachment means may be applied to the housing to fix this relative to the panel, e.g. a threaded nut engaged with a threaded portion of the housing.

### BRIEF DESCRIPTION OF DRAWINGS

The invention will now be described further by way of example only and with reference to the accompanying drawings in which:

FIG. 1 is a perspective view of part of a push button assembly according to one embodiment of the invention for use with an amusement or gaming machine;

FIG. 2 is a plan view of the arrangement of FIG. 1;

FIG. 3 is a diagrammatic side view of the arrangement of FIG. 1; and

FIG. 4 is an exploded diagrammatic view of the push button assembly.

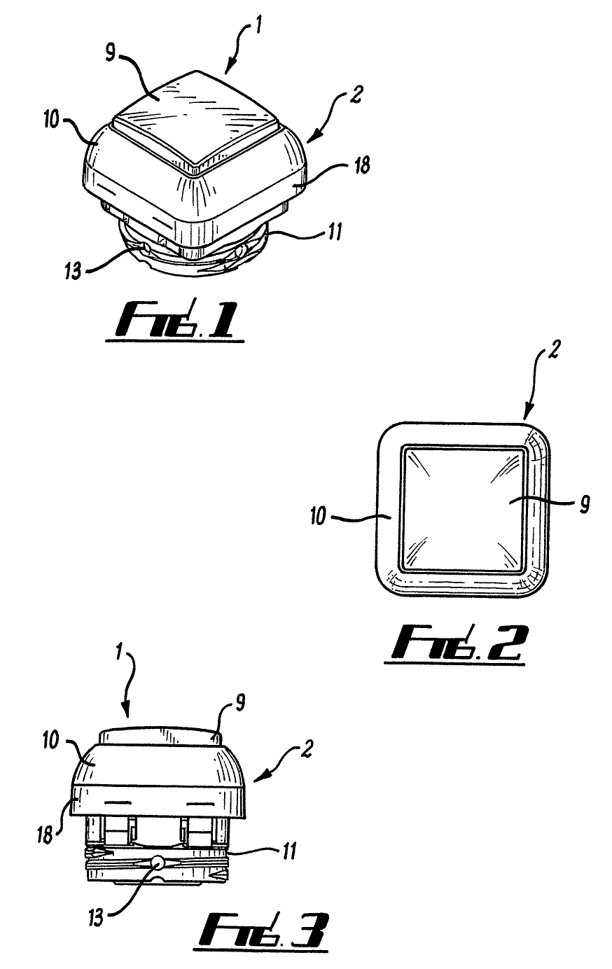

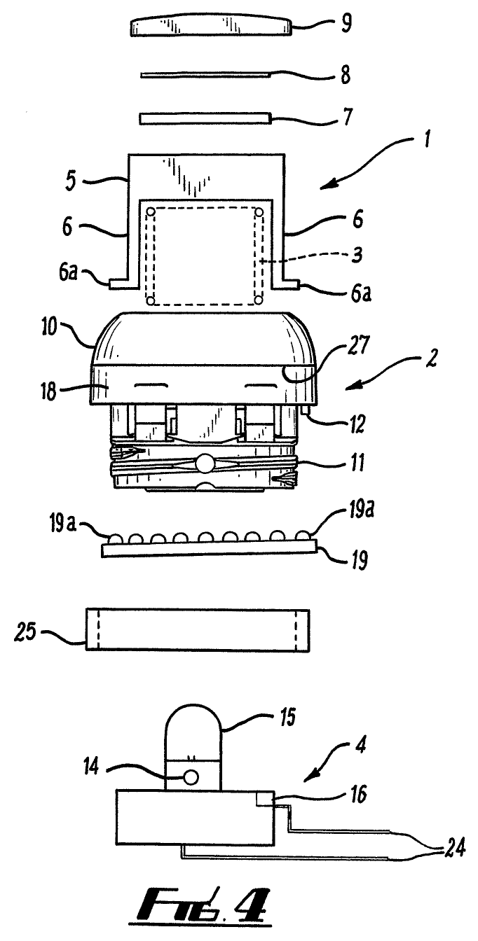

### MODES FOR CARRYING OUT THE INVENTION

As shown in FIG. 4 a push button assembly comprises a light-transmitting button 1, a first illumination means 15, a second illumination means 19, a housing 2, an electrical switch unit 4 and a switch actuating structure.

The housing 2 comprises a hollow cylindrical body 11 with an external screw thread and an integral outwardly projecting flange 10 around a top end of the body 11. The flange 10 has an inclined or curved outer face and is tapered upwardly. The body 11 is of circular cross section but the flange 10 is generally square and bounds a square top opening of the housing 2. The flange 10 has a flat under face 27 which extends radially outwardly from the body. Beneath the flange there is a peripheral annular part 18 which is of cross-sectional shape and size essentially the same as the shape and size of the flat face 27 of the flange. The part 18 is therefore generally square and has generally flat upright outer side walls although these may be slightly inclined to taper upwardly. The part 18 thereby defines a skirt beneath the flange 10 and the part 18 may be formed integrally with or separate to the flange 10. If separate the part 18 may be attached or keyed to the flange 10. The flange 10 is opaque and the part 18 is transparent or translucent.

A generally square circuit board 19 having a central aperture is located underneath the skirt part 18 of the flange 10 with the body 11 of the housing passing through the aperture. Individual LEDs 19a are located around the periphery of the board 19 in a close arrangement, and each LED 19a is connected to appropriate circuitry so as to be individually controllable.

A downwardly projecting locating pin 12 is attached beneath the part 18 on a radially extending flat bottom face thereof, although this is optional.

The light-transmitting button 1 comprises a square flat cover plate 7, a square upwardly slightly domed cap 9 and an intermediate printed and/or coloured insert 8. These parts of the button 1 fit within the opening of the flange 10 with the cap 9 projecting slightly above the flange 10 such that the button 1 is held captive relative to the flange 10 but can move upwardly and downwardly to a limited effect.

The switch actuating structure is held captive within the cylindrical body beneath the button 1 and comprises a cylindrical stem 5 provided with two spring legs 6 with outwardly turned feet 6a which fit beneath the bottom rim of the housing body and hold the stem 5 in place in the housing 2 against the action of a spring 3 which is located within the stem 5 and engages the stem at its upper end and an abutment within the body of the housing 2 at its lower end.

The first illumination means and the electrical switch 16 are provided by an integrated lamp-switch unit 4. In the lamp-switch unit 4, the electrical switch 16 is a microswitch having a generally rectangular body with an upwardly projecting operating member at one end of its top face and the illumination means is in the form of a lamp 15, which projects upwardly and is mounted on top of the body of the microswitch. The unit fits into the bottom end of the housing 2 and is held in position by means of pins 14 engageable with a locating hole in the body 11 such that the lamp 15 projects axially within the housing body and within the stem 5 and spring 3 and one of the feet 6a of the actuating structure is aligned with the operating member of the microswitch 16 which is located wholly externally of the housing body. Connection terminals for the lamp and the switch depend from the unit externally of the housing body.

The flange 10 is made from an opaque plastics material and defines a non-illuminable bezel around the button.

The second illumination means is provided by the discrete LEDs 19a on said board 19 which are positioned adjacent to the internal periphery of the light transmitting part 18. The circuitry of the said board 19 passes through the body 11 for connection to circuitry (not shown).

In an alternative arrangement an electroluminescent wire can be mounted around the inner or outer periphery of the part 18, e.g. in a peripheral groove. The wire may project free of the part 18 in the latter arrangement although the part 18 may behave as a cover part in the former arrangement.

In use, the housing body is inserted through a circular aperture in a panel of an amusement or the gaming machine, which may be a glass, metal, plastics or other panel, with the flange 10, part 18 and button 1 on the outer side of the panel. If provided, the pin 12 engages with a hole in the panel for location purposes.

The two illumination means and the switch are connected to the operating circuitry of the amusement or gaming machine.

At appropriate stages in the game played with the machine the button assembly is operable to initiate or control a machine function. In this case, the button can be pressed by a player whereby the button is depressed, the stem of the actuating structure is slided axially downwardly against the pressure of the spring and one of the feet engages the operating member of the microswitch to operate the switch and supply an electrical signal to the machine operating circuitry.

In conventional manner, the button can be illuminated with a steady or flashing light to indicate that the assembly is available for operation, by supply of power to the lamp which is located immediately below the light transmitting cover.

Also on appropriate occasions power can be supplied to the discrete LEDs 19a to cause them to be illuminated. Illumination of the LEDs 19a together causes a ‘halo’ ring of light to be produced in a closed-loop square boundary around the button. The light extends in a narrow strip or line shaped path.

This ‘halo’ ring is defined as a consequence of the positioning and characteristics of the LEDs in conjunction with the positioning, shape and characteristics of the part 18.

The ‘halo’ ring is controllable separately from the illumination of the button and this gives a range of indication possibilities. Due to the LEDs 19a being individually controllable, they may be illuminated in turn to create discrete points of light to the boundary, and/or a partially lit boundary. Therefore lighting effects such as a “travelling halo” might be achieved. The opaque flange 10 defines a non-illuminated boundary between the button and the ‘halo’.

Thus the button may be illuminated when it can be used to indicate or control one machine function or game feature and the ‘halo’ ring may be illuminated when the button can be used to indicate or control a different machine function or game feature.

The button illumination may be constant or flashing. The ‘halo’ illumination may also be constant of flashing and may be of different colours whereby there is a wide range of illumination combinations which can be used to give a wide range of game play indications.

Additionally or alternatively, the ‘halo’ may be used not to indicate an active status of the button, but when illuminated without the illumination of the lamp, may function as an “attract” mode or the like, when the machine is not actuated for play.

It is of course to be understood that the invention is not intended to be restricted to the details of the above embodiment, which is described by way of example only. Thus for, example, instead of using discrete LEDs, there may be a continuous strip or line shaped source for the second illumination means such as an electroluminescent wire or an electroluminescent film subject to the appropriate construction and arrangement of the source or sources to define a boundary path of light.

1. A push button assembly comprising an electrical switch, a light transmitting button movable to operate the switch, a first illumination means for illuminating the button, and a second illumination means for illuminating a boundary at least partially around the button, wherein the first and second illumination means are controllable separately and the boundary is illuminable independently of the actuation status of the button.

2. A push button assembly according to claim 1 wherein the first and second illumination means comprises separate illumination sources which are operable separately.

3. A push button assembly according to claim 1 wherein the first and second illumination means share a common illumination source with separately controllable illumination links.

4. A push button assembly according to claim 3 wherein the links are between the source and the button and the boundary.

5. A push button assembly according to claim 1 wherein the illuminable boundary extends partially around the button.

6. A push button assembly according to claim 1 wherein the illuminable boundary extends wholly around the button.

7. A push button assembly according to claim 1 wherein the illuminable boundary extends around the button in an independently illuminable segment or in a plurality of independently illuminable segments.

8. A push button assembly according to claim 1 wherein the illuminable boundary extends around the button in a plurality of independently illuminable segments.

9. A push button assembly according to claim 7 wherein the segment extends in a closed or substantially closed track around the button, thereby defining a ‘halo’ ring.

10. A push button assembly according to claim 1 wherein the boundary is curved or angular.

11. A push button assembly according to claim 7 wherein the (or each) segment of the boundary provides an elongate visually continuous light path.

12. A push button assembly according to claim 11 wherein the light path is a narrow line or strip.

13. A push button assembly according to claim 11 wherein the continuous light strip is achieved by closely adjacent multiple light sources.

14. A push button assembly according to claim 1 wherein the first and second illumination means, the light-transmitting button and the switch are mounted on a housing.

15. A push button assembly according to claim 1 wherein the first illumination means comprises a lamp or LED mounted with the housing.

16. A push button assembly according to claim 15 wherein the lamp is integrally formed with the switch to form a unit therewith which is detachably engageable with the housing.

17. A push button assembly according to claim 14 wherein the housing has a peripheral flange around an open top end of the housing thereby defining a bezel around the button.

18. A push button assembly according to claim 17 wherein the second illumination means is located beneath the flange.

19. A push button assembly according to claim 18 wherein a peripheral part separate from the flange is provided which is light-transmitting.

20. A push button assembly according to claim 1 wherein the second illumination means comprises a series of discrete LEDs.

21. A push button assembly according to claim 20 wherein the LEDs are provided on a printed circuit board.

22. A push button assembly according to claim 21 wherein the LEDs are arranged around a periphery of said board.

23. A push button assembly according to claim 20 wherein each LED is individually controllable.

24. A push button assembly according to claim 1 wherein the second illumination means emits white or colored light when energized to emit a single colored or multi-colored line of light.

25. A push button assembly according to claim 1 wherein the push button assembly has separate electrical connections or terminals for the two illumination means so that they may be separately controllable.

26. A push button assembly according to claim 25 wherein the push button assembly is mounted on a panel of an amusement or gaming machine and the separate connectors or terminals are connected to the operating circuitry of said machine.

27. An entertainment machine operable under the control of an operating system to play a game when actuated by credit of a predetermined stake value, said machine comprising at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, and the button assembly is actuable in first and second modes for initiating first and second different respective said game steps and in each said mode the button is arranged to be illuminated by a respective one of the first and second said illumination means.

28. An entertainment machine operable under the control of an operating system to play a game when actuated by credit of a predetermined stake value, said machine comprising at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, the button assembly being actuable in first and second modes for initiating first and second different respective said game steps and in each said mode the button is arranged to be illuminated by a respective one of the first and second said illumination means, and wherein the machine is also operable in an attract mode when not actuated as aforesaid to play a game, the second illumination means being operable in said attract mode for illuminating the button, but not the first illumination means.

29. An entertainment machine operable under the control of an operating system to play a game when actuated by credit of a predetermined stake value, said machine comprising at least one button assembly connected to the operating system operable when actuated for initiating one or more steps in said game, whereby said button assembly comprises an electrical switch, a light transmitting button movable to operate the switch, a first illumination means for illuminating the button and a second illumination means for illuminating around the button, wherein the first and second illumination means are controllable separately, and the second illumination means is arranged to illuminate a boundary at least partially around the button.

30. A method for operation of a push button assembly having an electrical switch, a light transmitting button movable to operate the switch, a first illumination means for illuminating the button and a second illumination means for illuminating a boundary, at least partially around the button, where the first and second illumination means are separately controllable, comprising the step of:
activating the second illumination means without activation of the first illumination means to indicate a mode of the button which does not indicate an active status of the button.
